(19) United States
(12) Patent Application Publication
(10) Pub. No.: US 2026/0308944 A1
(43) Pub. Date: Oct. 8, 2026

(54) DOOR LATCH DEVICE

(71) Applicant: U-Shin Ltd., Nagano (JP)

(72) Inventors: Nobuya AKAGI, Hiroshima (JP); Kohei YAMASAKI, Hiroshima (JP); Hideto TAKENAKA, Hiroshima (JP)

(21) Appl. No.: 18/998,307

(22) PCT Filed: Jul. 18, 2023
(86) PCT No.: PCT/JP2023/026190

§ 371 Date: Jan. 24, 2025

(30) Foreign Application Priority Data
Jul. 28, 2022 (JP) 2022-120849
Jul. 12, 2023 (JP) 2023-114489

(51) Int. Cl. E05B 77/10; E05B 79/08; E05B 79/20; E05B 81/14; E05B 81/90; E05B 85/02

(52) U.S. Cl. CPC E05B 77/10; E05B 79/08; E05B 79/20; E05B 81/14; E05B 81/90; E05B 85/02

(57) ABSTRACT

A door latch device includes a fence block, a fork rotatable between a latch position where a striker is held and an open position where holding of the striker is released, a claw rotatable between a locking position where the fork at the latch position is locked and an unlocking position where the fork is unlocked, a stopper restricting rotation of the claw beyond the locking position, and a caulking shaft (receiving portion) provided at an interval α on a side opposite to the fork in a direction in which the insertion groove extends with respect to the claw at the locking position.

### TECHNICAL FIELD

The present invention relates to a door latch device.

### BACKGROUND ART

A door latch device disclosed in Patent Document 1 includes a latch mechanism having a fork (latch) and a claw (pole). The latch mechanism is switched from a latched state to an unlatched state by operation of a handle provided to the door. In the latched state, the fork holds the striker and the claw locks the fork. To release the latch, the claw unlocks the fork and the fork disengages from the striker. The door can be opened by releasing the latch.

### Prior Art Document

### Patent Document

Patent Document 1: JP 2007-92465 A

### SUMMARY OF THE INVENTION

### Problems to be Solved by the Invention

At the time of vehicle collision, particularly at the time of side collision, the door is deformed by input of a collision load. When a large load is applied to the claw via the striker and the fork due to the deformation of the door, the claw may be displaced and disengaged from the fork, and the latch mechanism may switch from the latched state to the unlatched state. There is room for improvement in the door latch device described in Patent Document 1 with respect to prevention of door opening caused by such unintended unlatching.

An object of the present invention is to provide a door latch device capable of preventing unlatching due to deformation of a door caused by input of a collision load.

### Solutions to the Problems

One aspect of the present invention provides a door latch device including: a base member having an insertion groove through which a striker is to be inserted; a fork that is disposed on the base member and is rotatable between a latch position at which the striker is held and an open position at which holding of the striker is released; a claw that is disposed on the base member, is rotatable between a locking position at which the fork at the latch position is locked and an unlocking position at which the fork is unlocked, and is biased from the unlocking position side toward the locking position side; a restricting portion that restricts rotation of the claw beyond the locking position; and a receiving portion provided at an interval on a side opposite to the fork in a direction in which the insertion groove extends with respect to the claw at the locking position.

A receiving portion is provided at an interval on a side opposite to the fork in the direction in which the insertion groove extends with respect to the claw at the locking position. As a result, when the claw to which a collision load is applied via the striker and the fork is displaced in a direction of being detached from the fork, the claw comes into contact with the receiving portion. Therefore, displacement of the claw can be suppressed, and locking of the fork by the claw can be maintained. Accordingly, switching of the latch mechanism to unlatching can be prevented, so that unintentional opening of the door can be prevented. Moreover, the receiving portion is provided separately from the restricting portion that restricts rotation of the claw in the normal state, and is positioned at an interval with respect to the claw. Therefore, the claw and the receiving portion do not interfere with each other at the time of normal operation of the claw and traveling, and thus, it is possible to prevent generation of abnormal noise.

### Effects of the Invention

In the door latch device of the present invention, unlatching due to deformation of the door caused by input of a collision load can be prevented.

### BRIEF DESCRIPTION OF THE DRAWINGS

FIG. 1 is a plan view of a door latch device according to a first embodiment of the present invention in a state of being attached to a vehicle;

FIG. 2 is a perspective view of a door latch device from which a cover plate is removed;

FIG. 3 is an exploded perspective view of a fence block and a latch mechanism as viewed from the rear side in the vehicle length direction;

FIG. 4 is an exploded perspective view of a fence block and a latch mechanism as viewed from the front side in the vehicle length direction;

FIG. 5 is an exploded perspective view of a latch mechanism;

FIG. 6 is a front view of a latch mechanism in a latched state assembled to a fence block;

FIG. 7 is a rear view of FIG. 6;

FIG. 8 is an enlarged view of a latch mechanism in an unlatched state;

FIG. 9 is an enlarged view of a latch mechanism in a latched state which is a part IX in FIG. 6;

FIG. 10 is an enlarged view of a part X in FIG. 7;

FIG. 11 is an enlarged view of a latch mechanism in an unlocked state;

FIG. 12 is a cross-sectional view taken along line XII-XII of FIG. 9;

FIG. 13 is an enlarged view of a part XIII in FIG. 9;

FIG. 14 is an enlarged view of a door latch device according to a second embodiment in the same manner as FIG. 9;

FIG. 15 is a perspective view of a door latch device according to a third embodiment;

FIG. 16 is an enlarged view of a door latch device according to the third embodiment in the same manner as FIG. 9;

FIG. 17 is a cross-sectional view taken along line XVII-XVII of FIG. 16;

FIG. 18 is an enlarged view of a door latch device according to a fourth embodiment in the same manner as FIG. 9;

FIG. 19 is a cross-sectional view taken along line XIX-XIX of FIG. 18;

FIG. 20 is an enlarged view of a door latch device according to a fifth embodiment in the same manner as FIG. 9; and

FIG. 21 is a cross-sectional view taken along line XXI-XXI in FIG. 20.

### DETAILED DESCRIPTION

Hereinafter, embodiments of the present invention will be described with reference to the accompanying drawings.

### First Embodiment

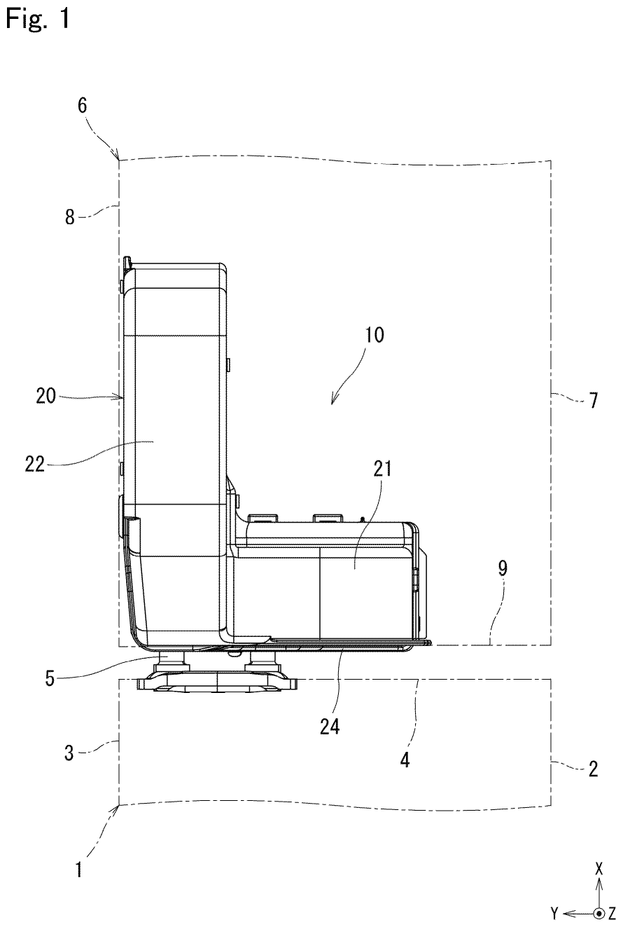

Referring to FIG. 1, a door latch device 10 according to a first embodiment of the present invention is disposed in a door 6 attached to a vehicle body 1 so as to be openable and closable.

An X direction in the accompanying drawings is a vehicle length direction, a direction indicated by an arrow is a front side, and a direction opposite to the arrow is a rear side. A Y direction is a vehicle width direction, a direction indicated by an arrow is a vehicle interior side, and a direction opposite to the arrow is a vehicle exterior side. A Z direction is a vehicle height direction, a direction indicated by an arrow is an upper side, and a direction opposite to the arrow is a lower side. Hereinafter, description will be given based on a state where the door 6 is closed.

Referring to FIG. 1, a vehicle body 1 includes an outer panel 2, an inner panel 3, and an end panel 4. The outer panel 2 and the inner panel 3 face each other in the vehicle width direction and extend along the XZ plane. The end panel 4 continues from the front end portion in the vehicle length direction of each of the outer panel 2 and the inner panel 3, and extends along the YZ plane. A striker 5 having a U shape as viewed from the vehicle height direction is attached to the end panel 4 so as to protrude in the vehicle length direction.

The door 6 includes an outer panel 7, an inner panel 8, and an end panel 9. The outer panel 7 and the inner panel 8 face each other in the vehicle width direction and extend along the XZ plane. The end panel 9 continues from the rear end portion in the vehicle length direction of each of the outer panel 7 and the inner panel 8, extends along the YZ plane, and faces the end panel 4 of the vehicle body 1. The door 6 is a general-purpose door rotatable by a hinge shaft extending in the vehicle height direction. However, the door 6 may be a gull-wing door that is rotatable by a hinge shaft extending in the vehicle length direction, a slide door that moves in the vehicle length direction along the vehicle body 1, or the like. The door 6 is a side door in the present embodiment, but may be a hatchback door.

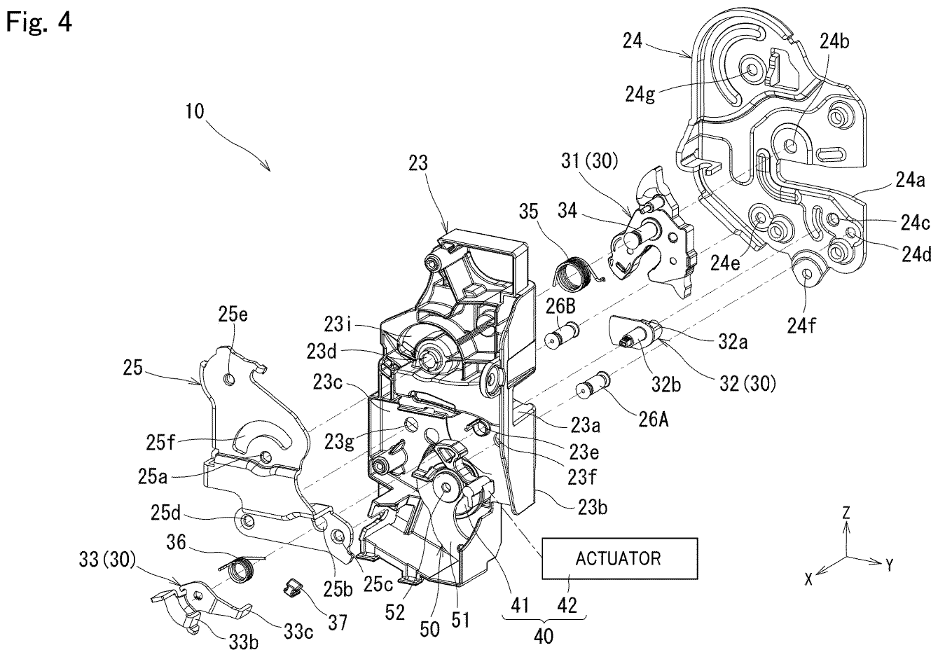

The door latch device 10 is disposed in the door 6 so as to be partially exposed from the end panel 9, and holds the striker 5 to hold the door 6 in the closed state with respect to the vehicle body 1. The door latch device 10 according to the present embodiment is of an electric type that releases the holding of the striker 5 by the driving force of an actuator 42 (see FIG. 4). Therefore, an exposed door handle that is manually openable is not provided inside and outside the door 6. In a case where a user in the vehicle opens the door 6, for example, the user operates a switch (not illustrated) provided to door 6. In a case where a user outside the vehicle opens the door 6, for example, the user operates an electronic key (not illustrated).

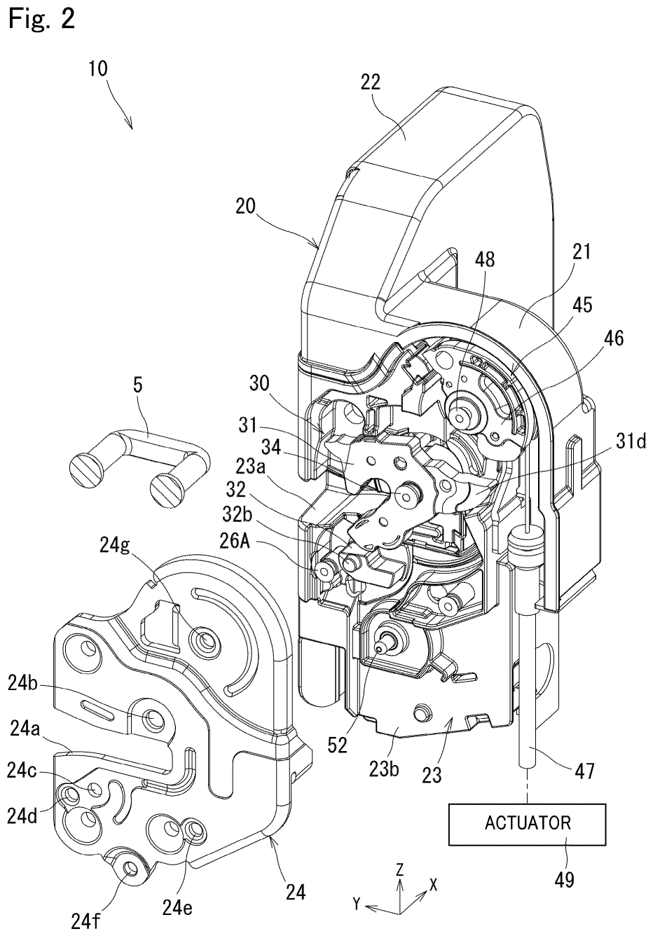

Referring to FIGS. 1 and 2, the door latch device 10 includes a housing 20 having an L shape when viewed from the vehicle height direction. Referring to FIGS. 2 to 4, the door latch device 10 includes a fence block (base member) 23, a latch mechanism 30, an electric release mechanism 40, and an electric closure mechanism 45 in the housing 20. In addition, the door latch device 10 includes a manual release mechanism 50 for emergency which is not used in a normal state and is used in an emergency in which the electric release mechanism 40 is inoperable.

Referring to FIGS. 1 and 2, the housing 20 includes a first accommodating portion 21 disposed to extend in the vehicle width direction along the inside of the end panel 9, and a second accommodating portion 22 disposed to extend in the vehicle length direction along the inside of the inner panel 8. The second accommodating portion 22 protrudes from an inner end of the first accommodating portion 21 in the vehicle width direction, and spatially communicates with the inside of the first accommodating portion 21.

The fence block 23 is disposed in the first accommodating portion 21 and includes an insertion groove 23a through which the striker 5 can be inserted. The insertion groove 23a is recessed from the outer surface 23b side (one surface side) on the rear side in the vehicle length direction to the inner surface 23c side (the other surface side) on the front side in the vehicle length direction, extends in the vehicle width direction, and has an inner end in the vehicle width direction and a rear end in the vehicle length direction opened.

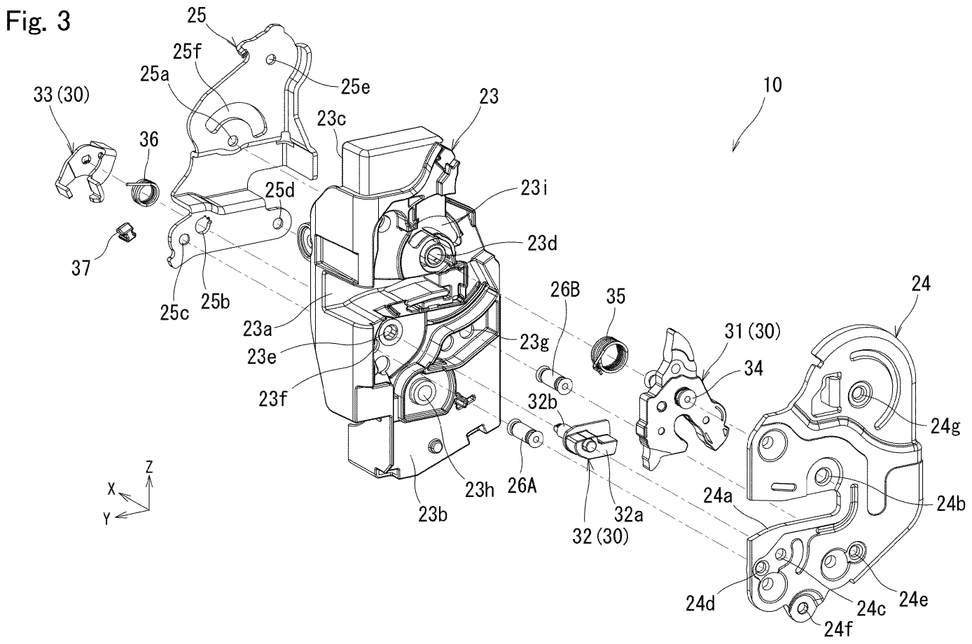

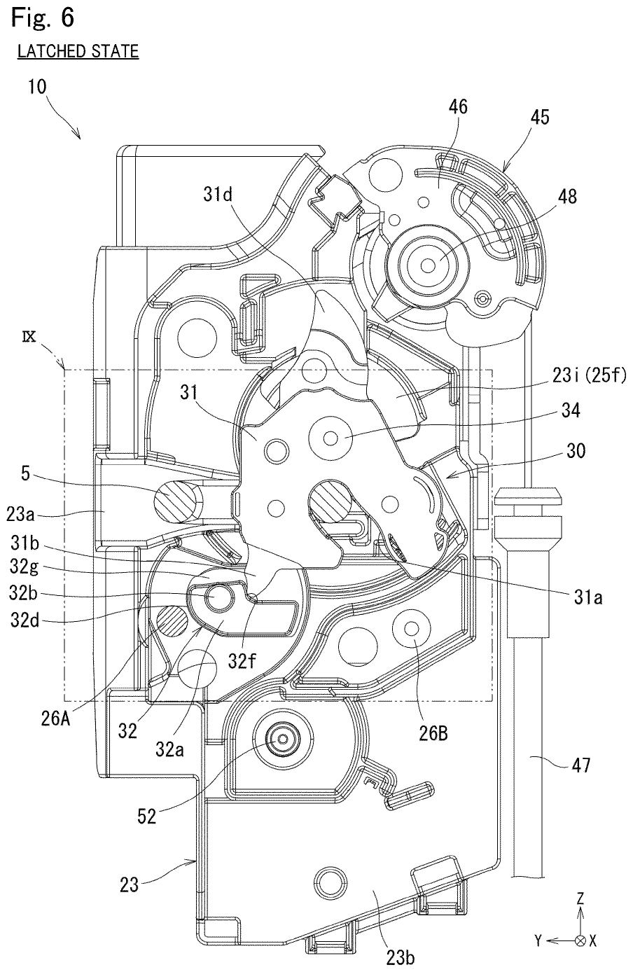

With reference to FIGS. 3 to 5, the latch mechanism 30 includes a fork 31, a claw 32 and an open lever 33. The fork 31 and the claw 32 are rotatably arranged on the outer surface 23b side of the fence block 23. The open lever 33 is disposed on the inner surface 23c side of the fence block 23 and is rotatable integrally with the claw 32. Referring to FIG. 6, a caulking shaft (receiving portion) 26A that suppresses unintended displacement of the claw 32 is disposed inside the claw 32 in the vehicle width direction. The caulking shaft 26A will be described in detail later.

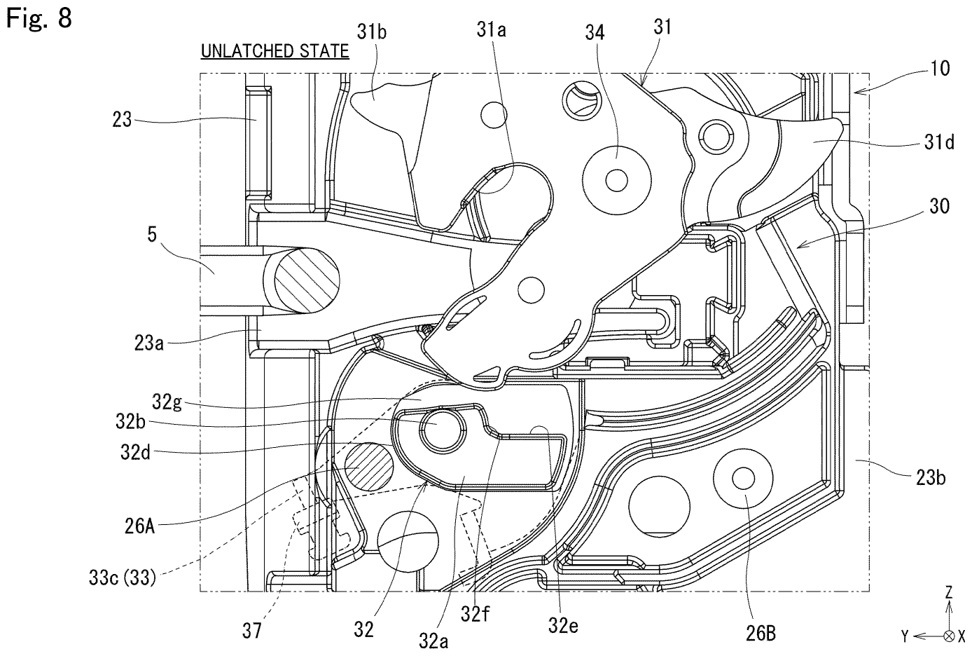

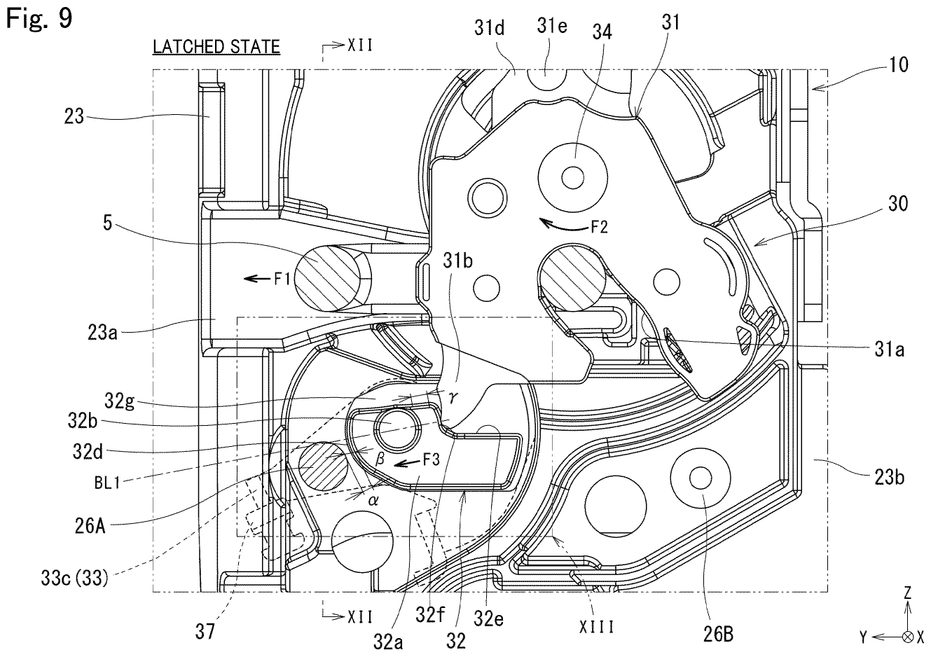

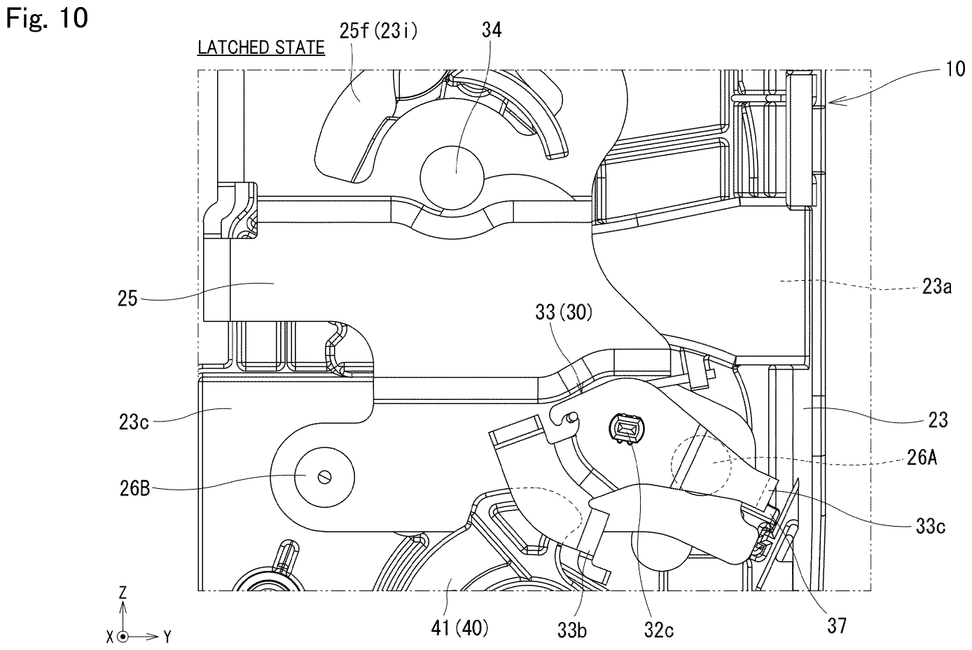

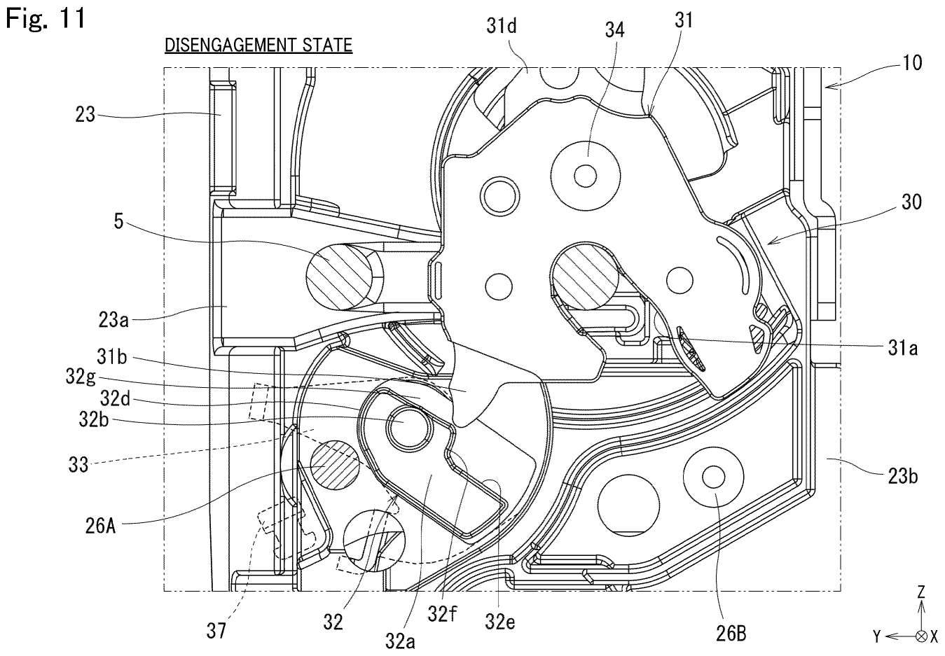

When the door 6 illustrated in FIG. 1 is closed in the unlatched state illustrated in FIG. 8, the entrance of the striker 5 causes the fork 31 to rotate counterclockwise to the latch position illustrated in FIG. 9, and the claw 32 locks the fork 31 holding the striker 5 to hold the door 6 in the closed state. When the open lever 33 at the initial position illustrated in FIG. 10 is rotated counterclockwise by the electric release mechanism 40 or the manual release mechanism 50, the claw 32 at the locking position illustrated in FIG. 9 is integrally rotated clockwise to the unlocking position illustrated in FIG. 11. As a result, the fork 31 at the latch position illustrated in FIG. 11 rotates clockwise to the open position illustrated in FIG. 8, and the latch mechanism 30 is switched to unlatching. As a result, the striker 5 can be detached from the fork 31, and the door 6 can be opened with respect to the vehicle body 1.

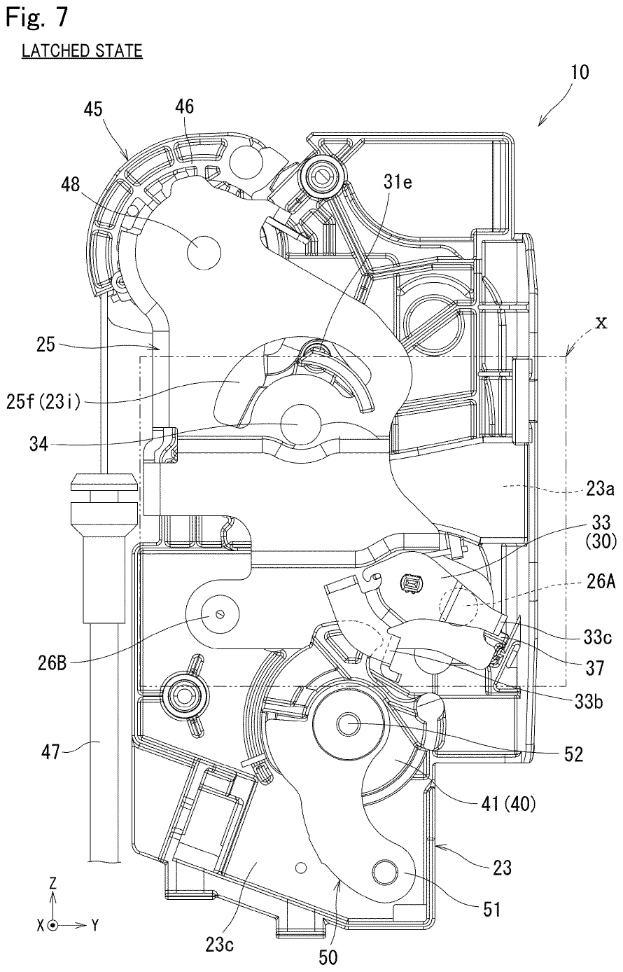

Referring to FIGS. 4 and 7, the electric release mechanism 40 includes the actuator 42 and an actuation member 41. The actuator 42 is disposed in the second accommodating portion 22 illustrated in FIG. 1. The actuation member 41 is rotatably disposed on the inner surface 23c side of the fence block 23.

The actuator 42 is operated by a control unit (not illustrated) to rotate the actuation member 41 clockwise in FIG. 7. As a result, the actuation member 41 rotates the open lever 33 counterclockwise, whereby the claw 32 in the locking position shown in FIG. 9 rotates to the unlocking position shown in FIG. 11, and the latch mechanism 30 switches to unlatching. When the actuator 42 is stopped, the actuation member 41 returns to the initial position illustrated in FIG. 7 by the biasing force of a torsion spring (biasing member) (not illustrated).

Referring to FIGS. 2, 6, and 7, the closure mechanism 45 includes an actuator 49 and a closure lever 46. The actuator 49 is disposed in the door 6 (see FIG. 1) which is the outside of the housing 20. The closure lever 46 is rotatably disposed between a cover plate 24 and a set plate 25 to be described in detail later, and is mechanically connected to the actuator 49 via a cable 47 routed on a side surface of the fence block 23.

When the door 6 in the open state is closed and the fork 31 in the open position illustrated in FIG. 8 rotates clockwise by a predetermined angle (for example, 39 degrees) toward the latch position illustrated in FIG. 9, the actuator 49 is driven by the control unit. As a result, the closure lever 46 rotates clockwise in FIG. 2 via the cable 47, and the fork 31 rotates to the latch position illustrated in FIGS. 6 and 9 by coming into contact with an operation receiving portion 31d to be described later. As a result, the claw 32 is locked to the fork 31, and the latch mechanism 30 is switched to the latched state.

Referring to FIGS. 4 and 7, the manual release mechanism 50 includes an operation lever 51. The operation lever 51 is disposed on the inner surface 23c side of the fence block 23, and is rotatably supported by the same rotation shaft 52 as the actuation member 41. An emergency lever is connected to the operation lever 51 via a cable (not illustrated). The emergency lever is disposed in the vehicle interior and is normally covered by a cover.

When the emergency lever is operated in an emergency, the operation lever 51 rotates clockwise in FIG. 7. As a result, the open lever 33 rotates via the actuation member 41, so that the claw 32 rotates from the locking position illustrated in FIG. 9 to the unlocking position illustrated in FIG. 11, and the latch mechanism 30 is switched to unlatching.

Hereinafter, configurations of the fence block 23, the latch mechanism 30, and the caulking shaft 26A will be described in more detail.

Referring to FIGS. 2 to 4, the fence block 23 is made of resin. Most of the outer surface 23b is covered with a metallic cover plate 24, and a part of the inner surface 23c is covered with a metallic set plate 25.

In the fence block 23, a through hole 23d through which the fork shaft (rotation shaft) 34 of the fork 31 passes is provided on the upper side of the insertion groove 23a. On the lower side of the insertion groove 23a, that is, on the side opposite to the fork 31 with respect to the insertion groove 23a, a through hole 23e through which a claw shaft (rotation shaft) 32b of the claw 32 passes is provided. The through hole 23e for the claw 32 is disposed at an interval on the inner side in the vehicle width direction with respect to the through hole 23d for the fork 31.

Through holes 23f, 23g, and 23h are further provided below the through hole 23e for the claw 32. The caulking shafts 26A and 26B for fixing the cover plate 24 and the set plate 25 to the fence block 23 pass through the through holes 23f and 23g, respectively. The rotation shaft 52 of the operation lever 51 passes through the through hole 23h. On the upper side of the through hole 23d for the fork 31, an arc-shaped restriction groove 23i that restricts the rotation angle range of the fork 31 is provided.

The cover plate 24 includes an insertion groove 24a corresponding to the insertion groove 23a. The cover plate 24 is provided with support holes 24b to 24f corresponding to the through holes 23d to 23h of the fence block 23. The cover plate 24 is also provided with a support hole 24g corresponding to the rotation shaft 48 of the closure lever 46.

The set plate 25 is bent along the shape of the inner surface 23c of the fence block 23. The set plate 25 is provided with support holes 25a to 25e corresponding to the support holes 24b to 24e and 24g of the cover plate 24. In addition, the set plate 25 is provided with a restriction groove 25f corresponding to the restriction groove 23i of the fence block 23.

By caulking and joining of the four shaft members, the cover plate 24 is fixed to the outer surface 23b of the fence block 23, and the set plate 25 is fixed to the inner surface 23c of the fence block 23. One of the four shaft members is a metal fork shaft 34 included in the fork 31. One of the four shaft members is a metal rotation shaft 48 included in the closure lever 46. The remaining two of the four shaft members are metal caulking shafts 26A and 26B disposed at intervals in the vehicle width direction.

Referring to FIGS. 2 and 6, the fork 31 is disposed above the insertion groove 23a of the fence block 23. The fork shaft 34 of the fork 31 passes through the fork 31, the through hole 23d of the fence block 23, the support hole 24b of the cover plate 24, and the support hole 25a of the set plate 25, and is caulked and joined to the cover plate 24 and the set plate 25. That is, one end of the fork shaft 34 is supported by the cover plate 24, and the other end of the fork shaft 34 is supported by the set plate 25. As a result, the fork 31 is rotatable around the fork shaft 34.

Referring to FIGS. 3 to 5, the fork 31 is biased from the latch position toward the open position by a torsion spring (biasing member) 35. The torsion spring 35 is disposed so as to surround the fork shaft 34, and has one end locked to the fence block 23 and the other end locked to the fork 31.

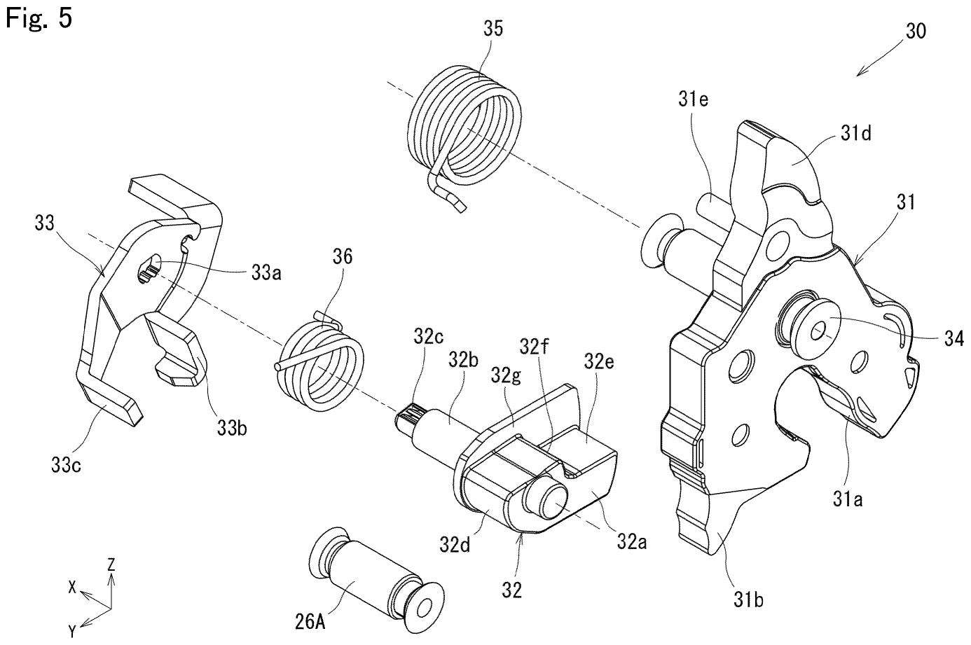

Referring to FIGS. 5 and 9, the fork 31 includes a holding groove 31a, a locking protrusion 31b, and an operation receiving portion 31d.

When the holding groove 31a is at the open position illustrated in FIG. 8, the holding groove extends obliquely upward toward the outside in the vehicle width direction, and the striker 5 can be detached. When at the latch position illustrated in FIG. 9, the holding groove 31a intersects with the insertion groove 23a, extends obliquely upward toward the fork shaft 34 toward the inside in the vehicle width direction, and holds the striker 5 in an undetachable manner.

The locking protrusion 31b is provided at a portion of the fork 31 located on the inner and lower side in the vehicle width direction when at the latch position illustrated in FIG. 9. The locking protrusion 31b protrudes in a substantially triangular shape.

The operation receiving portion 31d is provided at a portion located at the upper end and protrudes in a substantially triangular shape when at the latch position illustrated in FIG. 9. The operation receiving portion 31d is provided to rotate the entire fork 31 to the latch position in response to the operation of the closure lever 46 illustrated in FIG. 6. The operation receiving portion 31d is provided with a restricting protrusion 31e that penetrates the restriction groove 23i of the fence block 23 and the restriction groove 25f of the set plate 25.

Referring to FIGS. 3 to 5, the claw 32 has a configuration in which a claw shaft 32b is integrally formed with a claw body 32a in order to simplify the structure and improve the assemblability, and is disposed below the insertion groove 23a of the fence block 23. The claw shaft 32b protrudes from the claw body 32a to the front side and the rear side in the vehicle length direction, and is rotatable integrally with the claw body 32a. The rear end side of the claw shaft 32b in the vehicle length direction is rotatably supported by the support hole 24c of the cover plate 24. The front side of the claw shaft 32b in the vehicle length direction passes through the through hole 23e of the fence block 23 and is rotatably supported by the support hole 25b of the set plate 25. A mounting portion 32c having a non-circular cross section for mounting the open lever 33 is provided at the front end of the claw shaft 32b in the vehicle length direction.

The claw 32 is biased by a torsion spring (biasing member) 36 from an unlocking position illustrated in FIG. 11 toward a locking position illustrated in FIG. 9. The torsion spring 36 is disposed so as to surround the claw shaft 32b, and has one end locked to the fence block 23 and the other end locked to the open lever 33. That is, the torsion spring 36 biases the claw 32 via the open lever 33.

Referring to FIGS. 5 and 9, the claw body 32a is a block body that is long in the vehicle width direction and short in the vehicle height direction. A portion facing the caulking shaft 26A which is an inner end in the vehicle width direction of the claw body 32a (hereinafter referred to as “facing portion 32d”) has an arc shape centered on the claw shaft 32b. The claw body 32a is provided with a locking recess 32e and a flange portion 32g.

The locking recess 32e is provided adjacent to the right side of the claw shaft 32b which is a portion facing the locking protrusion 31b of the fork 31, and is uniformly recessed from the upper side to the lower side. By forming the locking recess 32e, a locking surface 32f is formed on the claw shaft 32b side. The locking surface 32f protrudes upward in the vehicle height direction from the bottom of the locking recess 32e, extends along the XZ plane in a state where the claw 32 is at the locking position, and locks the locking protrusion 31b of the fork 31.

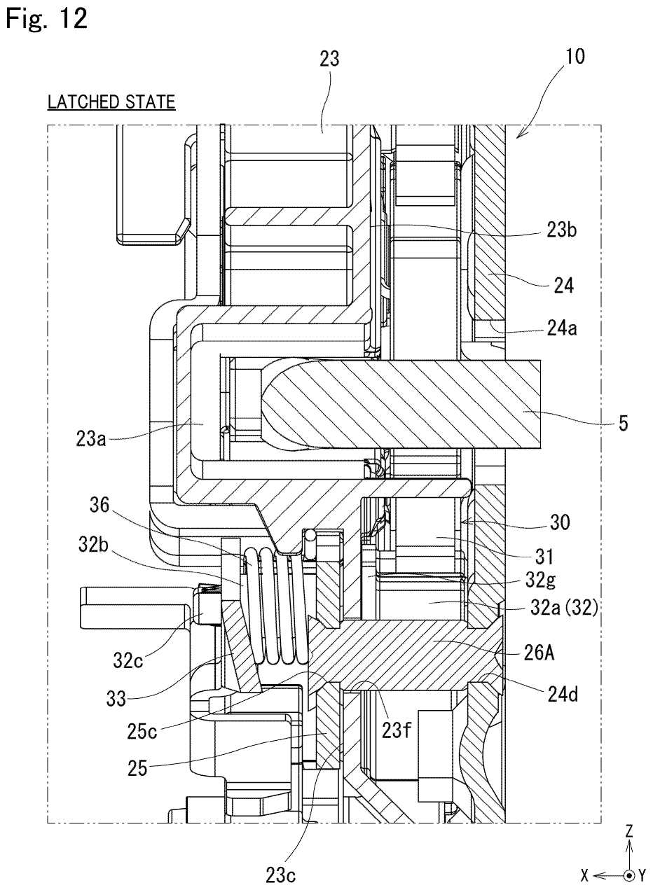

The flange portion 32g is provided at a portion facing the fence block 23 which is the front end of the claw body 32a in the vehicle length direction. The flange portion 32g protrudes from the outer periphery of the claw body 32a along the YZ plane, and closes the front end in the vehicle length direction of the locking recess 32e. Referring to FIG. 12, the thickness of the flange portion 32g in the vehicle length direction is a dimension that can be interposed between the fork 31 at the latch position and the fence block 23.

Referring to FIGS. 4, 5, and 10, the open lever 33 is disposed on a side opposite to the claw body 32a with respect to the fence block 23, more specifically, on the front side of the set plate 25 in the vehicle length direction. The open lever 33 includes a non-circular mounting hole 33a mounted on the mounting portion 32c of the claw shaft 32b, and rotates integrally with the claw 32. The open lever 33 is provided with an operation receiving portion 33b that receives the operation of the actuation member 41 and a contact piece 33c that comes into contact with a stopper 37. The open lever 33 is biased clockwise to an initial position illustrated in FIG. 10 by the torsion spring 36.

The stopper (restricting portion) 37 is made of an elastically deformable rubber, is arranged on the inner surface 23c side of the fence block 23, and is sandwiched by the set plate 25. The stopper 37 restricts the counterclockwise rotation of the claw 32 beyond the locking position illustrated in FIG. 9 by the contact of the contact piece 33c of the open lever 33.

At the time of vehicle collision, particularly side collision, the door latch device 10 exhibits the following behavior.

As conceptually indicated by an arrow in FIG. 9, when the door 6 illustrated in FIG. 1 is deformed by input of a collision load, a force F1 in a direction of exiting from the insertion groove 23a may relatively act on the striker 5. In this case, a force F2 rotating clockwise from the latch position toward the open position acts on fork 31 by the force F1. As a result, a force F3 in a direction of detaching from the fork 31 acts on the claw 32 locked to the fork 31. When the claw 32 is displaced by the force F3 and the displacement is excessive, the claw 32 is disengaged from the fork 31, the latch mechanism 30 in the latched state is switched to unlatching, and the door 6 illustrated in FIG. 1 may be opened.

In order to prevent unlatching due to deformation of the door 6 caused by such input of a collision load, in the present embodiment, the caulking shaft (receiving portion) 26A is disposed so as to suppress displacement of the claw 32.

Referring to FIGS. 2 and 9, the caulking shaft 26A is provided on the inner side in the vehicle width direction with respect to the claw 32 at the locking position, that is, on the side opposite to the fork 31 in the direction in which the insertion groove 23a extends, and receives the displacement of the claw 32 due to input of a collision load. In other words, the caulking shaft 26A is provided on the front side in the direction in which the claw 32 is displaced by the input of a collision load.

The caulking shaft 26A is a rigid body harder than the resin-made fence block 23, and extends parallel to the claw shaft 32b. Referring to FIG. 12, both ends of the caulking shaft 26A are respectively supported by the support hole 24d of the cover plate 24 and the support hole 25c of the set plate 25.

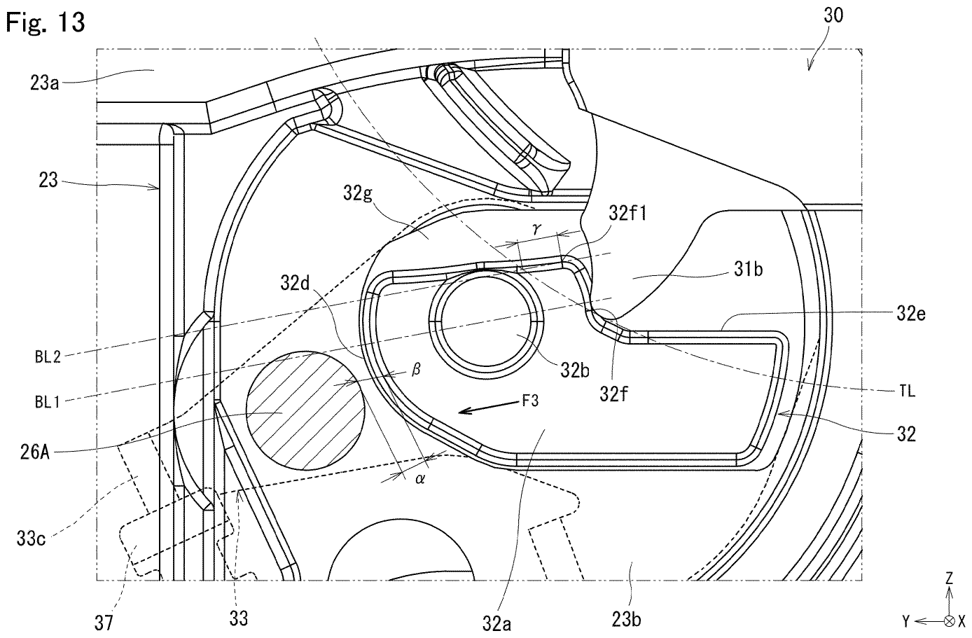

Referring to FIG. 13, the caulking shaft 26A is positioned at intervals α and β from the facing portion 32d of the claw body 32a in the direction in which the insertion groove 23a extends. That is, gaps of the intervals α and β are secured between the caulking shaft 26A and the claw body 32a. The interval a is the shortest distance between the caulking shaft 26A and the facing portion 32d of the claw body 32a. The interval β is the shortest distance between the caulking shaft 26A and the claw body 32a in the direction of the force F3 acting on the claw 32. In the present embodiment, a straight line (hereinafter, referred to as a “reference line BL1”), passing through the contact position of the locking protrusion 31b and the locking surface 32f and the center of the fork shaft 34 in a state where the claw 32 is locked to the fork 31 at the latch position, coincides with the direction of the force F3 acting on the claw 32. However, the direction of the force F3 acting on the claw 32 may be derived by a simulation using three-dimensional data of the door latch device 10, an experiment, or the like.

The interval α is equal to or less than the interval β (α≤β). These intervals α and β are smaller than the locking allowance y between the locking protrusion 31b of the fork 31 and the locking surface 32f of the claw 32 (α≤β<γ). The locking allowance γ means a movement range of the claw 32 in which the claw 32 can be locked to the fork 31 at the latch position, and is a distance between an intersection of a reference line BL2 that passes through an opened upper end 32f1 of the locking surface 32f and is parallel to the reference line BL1, and a rotation track of the tip of the locking protrusion 31b indicated by an imaginary line TL, and the upper end 32f1 of the locking surface 32f.

When the intervals α and β are excessively increased, there is a possibility that the locking of the locking protrusion 31b and the locking surface 32f is released before the claw 32 displaced by the input of a collision load comes into contact with the caulking shaft 26A. When the intervals α and β are excessively reduced, in the normal state where the claw 32 rotates between the locking position illustrated in FIG. 9 and the unlocking position illustrated in FIG. 11, there is a possibility that the claw body 32a interferes with the caulking shaft 26A due to an unavoidable product error or the like and impedes rotation of the claw 32. In order to prevent these inconveniences, it is preferable to provide the intervals α and β smaller than the locking allowance γ of the locking protrusion 31b and the locking surface 32f between the caulking shaft 26A and the claw body 32a. For example, when the locking allowance γ is 1.55 mm, the intervals α and β are preferably larger than 0 mm and smaller than 1 mm (more specifically, 0.5 mm±0.5 mm).

Referring to FIG. 12, the caulking shaft 26A is provided at a position overlapping the claw body 32a when viewed from the direction in which the insertion groove 23a extends (vehicle width direction). The diameter of the caulking shaft 26A of the present embodiment is smaller than the width from the upper end to the lower end of the claw body 32a at the locking position. The position overlapping the claw body 32a means that at least a part of the caulking shaft 26A is positioned within the width of the claw body 32a in the vehicle height direction, and in the present embodiment, the entire caulking shaft 26A is positioned within the width of the claw body 32a.

Referring to FIG. 9, the caulking shaft 26A is disposed on the reference line BL1 extending along the insertion groove 23a of the fence block 23. The disposition on the reference line BL1 means that a part of the cross section of the caulking shaft 26A is located on the reference line BL1, and in the present embodiment, the cross-sectional center of the caulking shaft 26A is located below the reference line BL1 at an interval.

In the case of the door latch device 10 in which the caulking shaft 26A is disposed in this manner, as illustrated in FIG. 9, when the force F3 is applied to the claw 32 via the striker 5 and the fork 31 when the door 6 is deformed by the input of a collision load, the claw 32 displaced in the direction of the force F3 comes into contact with the caulking shaft 26A. Since the intervals α and β between the claw 32 and the caulking shaft 26A are smaller than the locking allowance γ between the fork 31 and the claw 32, the claw 32 can come into contact with the caulking shaft 26A before the unlocking of the fork 31 by the claw 32. As a result, the latch mechanism 30 can be prevented from being unlatched due to the deformation of the door 6 caused by the input of a collision load.

The door latch device 10 configured as described above has the following features.

The caulking shaft (receiving portion) 26A is provided at the interval α on the side opposite to the fork 31 in the direction in which the insertion groove 23a extends with respect to the claw 32 at the locking position. As a result, when the claw 32 to which the collision load is applied is displaced in a direction away from the fork 31, the claw comes into contact with the caulking shaft 26A. Therefore, displacement of the claw 32 and deformation of the claw shaft 32b can be suppressed, and locking of the fork 31 by the claw 32 can be maintained. Therefore, switching of the latch mechanism 30 to unlatching can be prevented, so that unintentional opening of the door 6 can be prevented. The caulking shaft 26A is provided separately from the stopper 37 that restricts the rotation of the claw 32, and is located at the interval α with respect to the claw 32. Therefore, the claw 32 and the caulking shaft 26A do not interfere with each other during normal operation of the claw 32 and traveling, so that generation of abnormal noise can be prevented.

The intervals α and β between the caulking shaft 26A and the claw 32 are smaller than the locking allowance γ between the claw 32 at the locking position and the fork 31 at the latch position. As a result, the claw 32 comes into contact with the caulking shaft 26A before the locking with the fork 31 is released by the displacement of the claw 32. Therefore, the locking of the claw 32 to the fork 31 can be reliably maintained, and unintentional opening of the door 6 can be reliably prevented.

When viewed from the direction in which the insertion groove 23a extends, the caulking shaft 26A is provided at a position overlapping the claw 32. As a result, the displaced claw 32 can be received by the caulking shaft 26A. Therefore, the locking of the claw 32 to the fork 31 can be reliably maintained, and unintentional opening of the door 6 can be reliably prevented.

The facing portion 32d facing the caulking shaft 26A of the claw 32 has an arc shape centered on the claw shaft 32b. As a result, the displaced claw 32 can be reliably received by the caulking shaft 26A. In addition, since the claw 32 and the caulking shaft 26A do not interfere with each other during normal operation of the claw 32 and traveling, generation of abnormal noise can be effectively prevented.

The claw 32 has the flange portion 32g interposed between the fork 31 at the latch position and the fence block 23. The flange portion 32g thus prevents displacement of the claw 32 in the vehicle length direction along the claw shaft 32b. Therefore, the locking of the claw 32 to the fork 31 can be reliably maintained, and unintentional opening of the door 6 can be reliably prevented.

The caulking shaft 26A is a rigid body harder than the fence block 23, and both ends thereof are supported by the cover plate 24 and the set plate 25 made of metal, respectively. As a result, displacement and deformation of the caulking shaft 26A itself can be suppressed, and the displaced claw 32 can be reliably received, so that switching of the latch mechanism 30 to unlatching can be reliably prevented.

Hereinafter, other embodiments and various modifications of the present invention will be described, but points not particularly mentioned in these descriptions are the same as those of the first embodiment. In the drawings referred to below, the same elements as those of the first embodiment are denoted by the same reference numerals.

### Second Embodiment

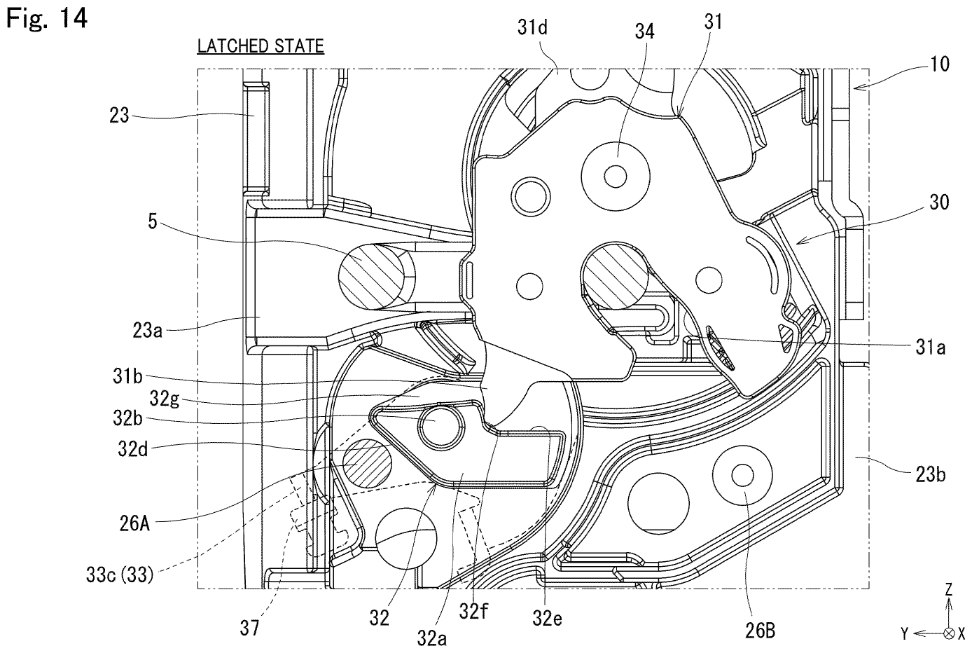

Referring to FIG. 14, a door latch device 10 of the second embodiment is different from that of the first embodiment shown in FIG. 9 only in the shape of a claw body 32a. Specifically, in the second embodiment, the facing portion 32d of the claw body 32a is inclined in a direction approaching the fork shaft 34 as approaching the caulking shaft (receiving portion) 26A. A part of the facing portion 32d on the inner end side in the vehicle width direction is disposed above the upper end of the caulking shaft 26A and inside the outer end of the caulking shaft 26A in the vehicle width direction, and the remaining portion of the facing portion 32d is disposed below the upper end of the caulking shaft 26A and outside the outer end of the caulking shaft 26A in the vehicle width direction. That is, the inner end of the facing portion 32d is located closer to the fork shaft 34 side than the upper end of the caulking shaft 26A in the vehicle height direction, and is located farther from the fork 31 than the outer end of the caulking shaft 26A in the direction in which the insertion groove 23a extends.

In the door latch device 10 of the second embodiment, when the claw 32 is displaced via the striker 5 and the fork 31 by input of a collision load, the inclined facing portion 32d functions as a guide portion. Specifically, when the facing portion 32d comes into contact with the caulking shaft 26A, the entire claw 32 moves toward the fork shaft 34, that is, in a direction in which the locking allowance between the claw 32 and the fork 31 becomes deep. Therefore, the locking of the claw 32 to the fork 31 can be reliably maintained, and switching of the latch mechanism 30 to unlatching can be prevented. Therefore, unintended opening of the door 6 (see FIG. 1) can be reliably prevented.

### Third Embodiment

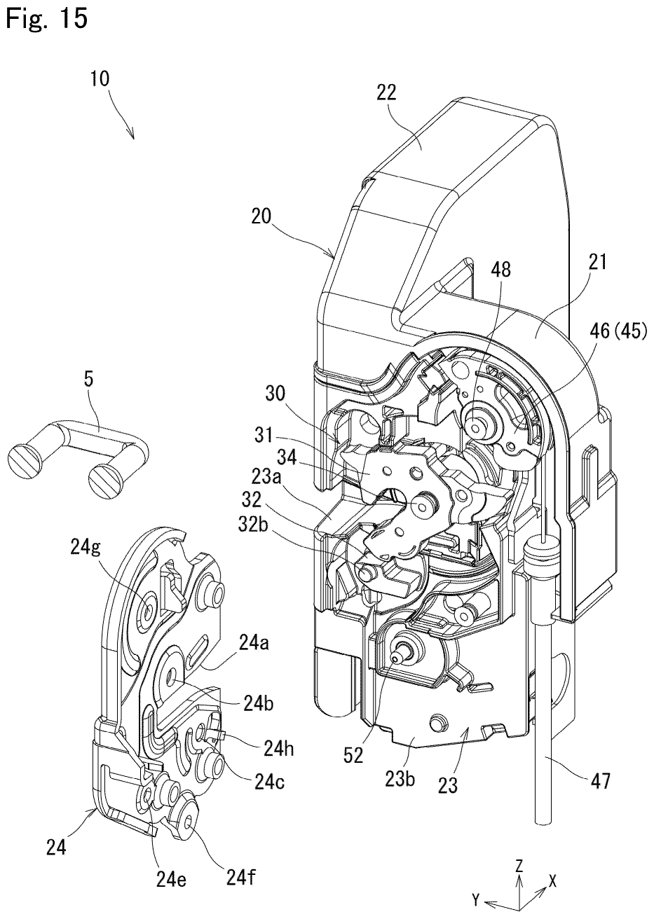

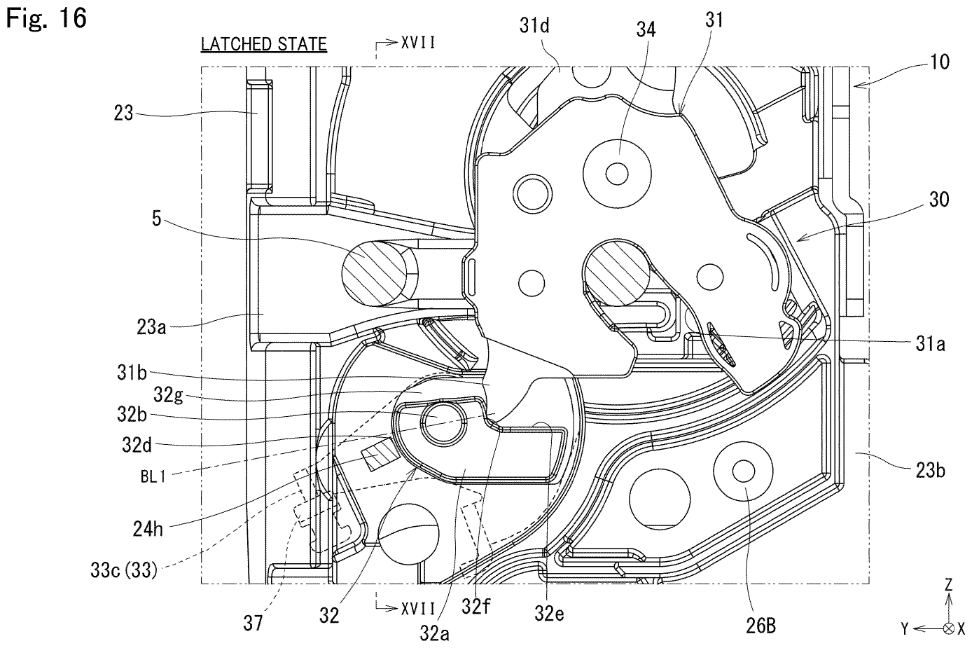

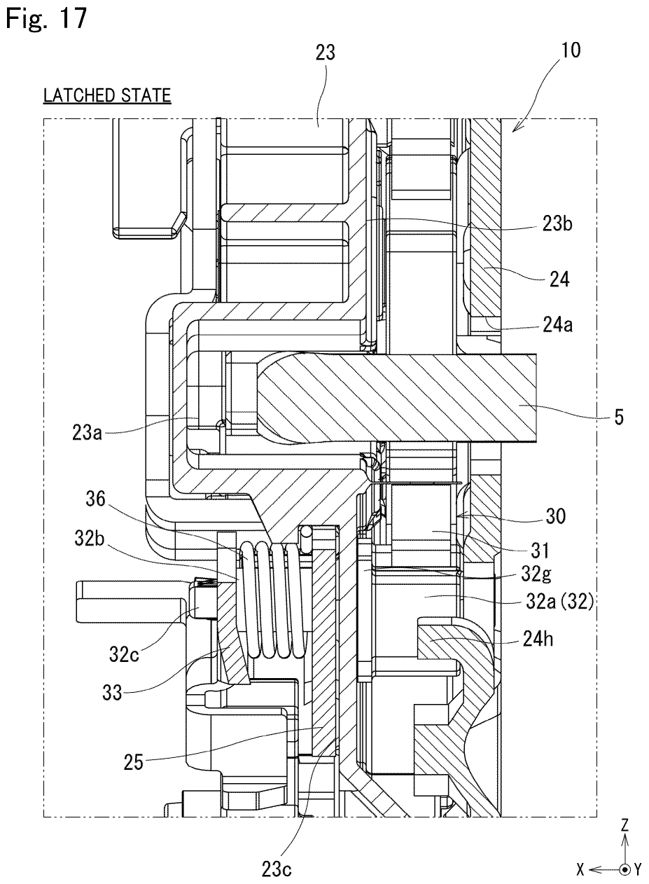

Referring to FIGS. 15 to 17, a door latch device 10 of the third embodiment is different from that of the first embodiment shown in FIG. 9 only in the configuration of a receiving portion. Specifically, the receiving portion of the third embodiment includes a cut and raised piece 24h formed on a cover plate 24 made of metal which is a rigid body harder than the fence block 23. The cover plate 24 is provided with an inverted U-shaped punched groove, and a portion positioned in the punched groove is bent forward in the vehicle length direction to form the cut and raised piece 24h. With the assembly of the cover plate 24 to the fence block 23, the cut and raised piece 24h is disposed at an interval from the inside of the claw 32 in the vehicle width direction as illustrated in FIG. 16, extends along the reference line BL1, and is located within the width of the claw 32 in the vehicle height direction as illustrated in FIG. 17.

In the door latch device 10 of the third embodiment, when the claw 32 is displaced via the striker 5 and the fork 31 by input of a collision load, the displaced claw 32 can be received by the cut and raised piece 24h as in the first embodiment. This prevents the claw 32 from unlocking the fork 31, thereby preventing the latch mechanism 30 from switching to unlatching and preventing unintended opening of the door 6 (see FIG. 1). In addition, since the receiving portion includes the cut and raised piece 24h provided on the cover plate 24 and it is not necessary to add a dedicated component, it is possible to prevent the assembly work from being complicated.

### Fourth Embodiment

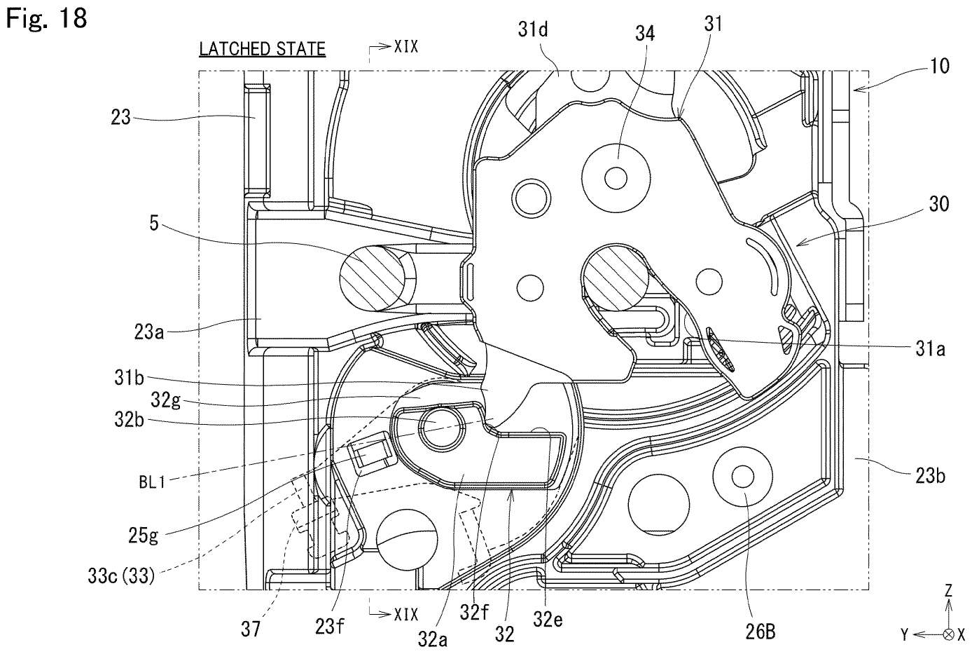

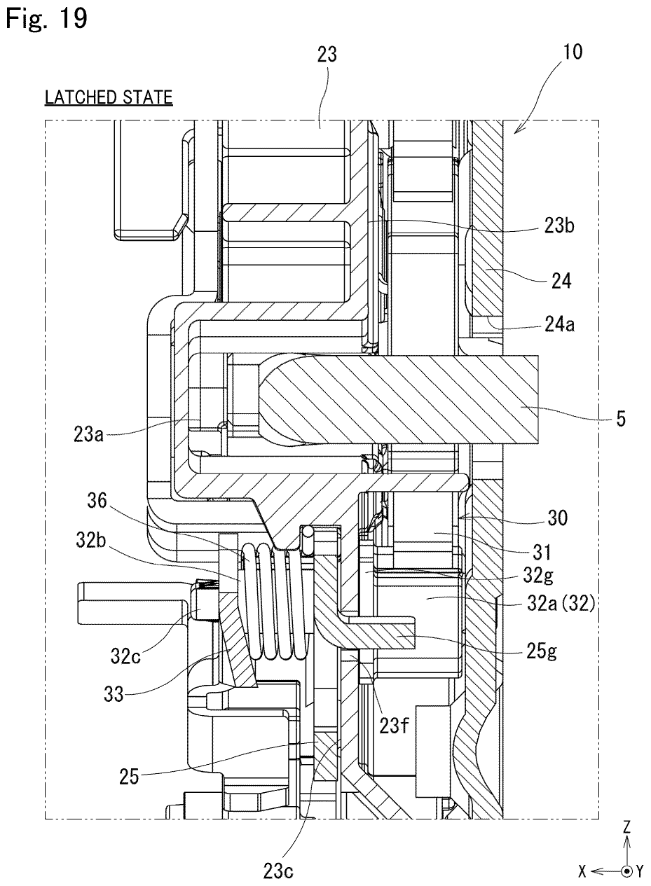

Referring to FIGS. 18 and 19, a door latch device 10 of the fourth embodiment is different from that of the first embodiment shown in FIG. 9 only in the configuration of a receiving portion. Specifically, the receiving portion of the fourth embodiment includes a cut and raised piece 25g formed on the set plate 25 made of metal which is a rigid body harder than the fence block 23. A U-shaped punched groove is provided in the set plate 25, and a portion positioned in the punched groove is bent to the rear side in the vehicle length direction, thereby forming the cut and raised piece 25g. With the assembly of the set plate 25 to the fence block 23, the cut and raised piece 25g is disposed at an interval from the inside of the claw 32 in the vehicle width direction through the through holes 23f, extends along the reference line BL1, and is located within the width of the claw 32 in the vehicle height direction.

In the door latch device 10 of the fourth embodiment, when the claw 32 is displaced via the striker 5 and the fork 31 by input of a collision load, the displaced claw 32 can be received by the cut and raised piece 25g as in the first embodiment. This prevents the claw 32 from unlocking the fork 31, thereby preventing the latch mechanism 30 from switching to unlatching and preventing unintended opening of the door 6 (see FIG. 1). In addition, since the receiving portion includes the cut and raised piece 25g provided on the set plate 25 and it is not necessary to add a dedicated component, it is possible to prevent the assembly work from being complicated.

### Fifth Embodiment

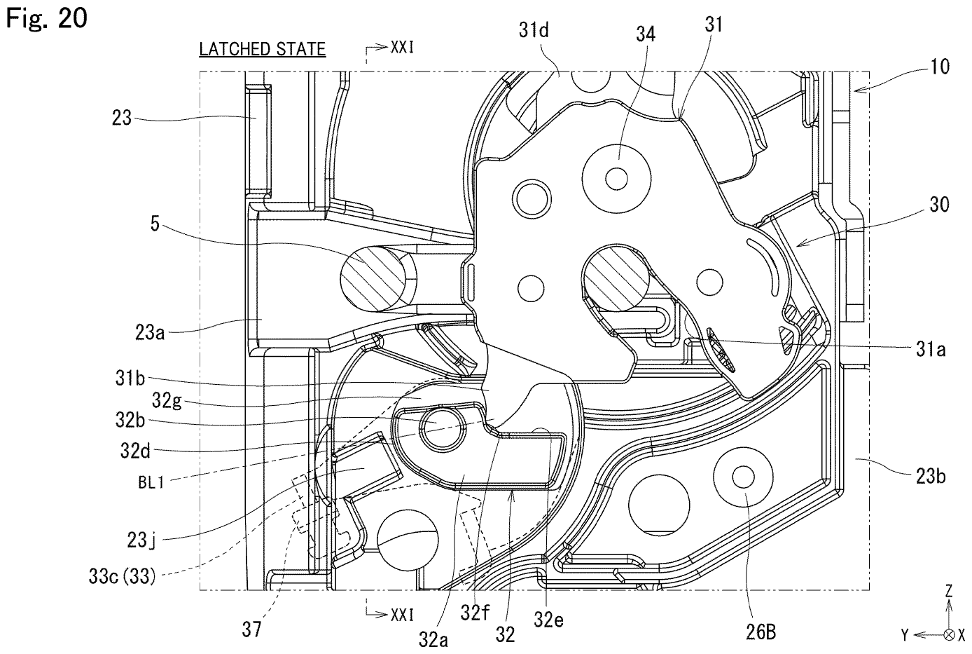

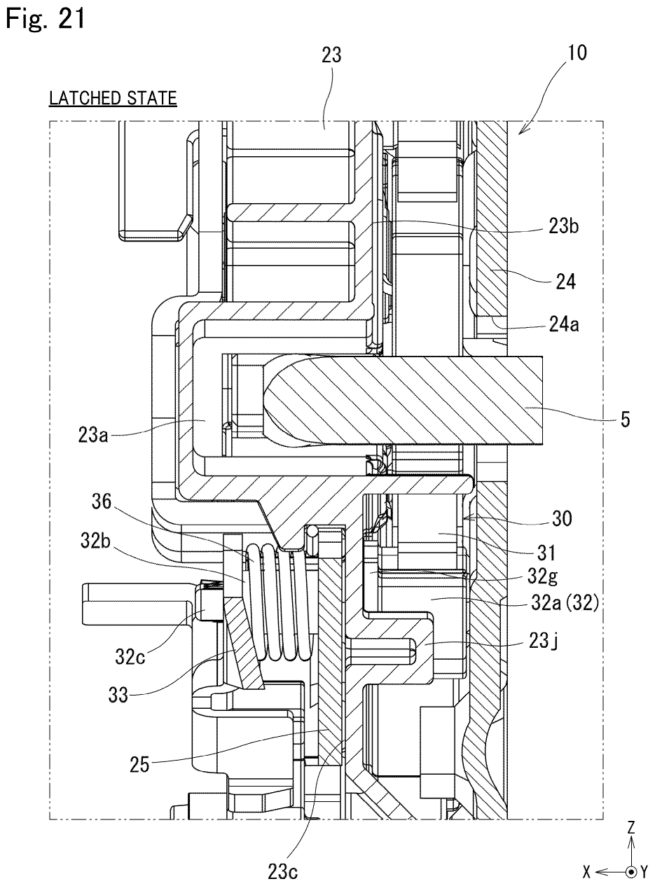

Referring to FIGS. 20 and 21, a door latch device 10 of the fifth embodiment is different from that of the first embodiment shown in FIG. 9 only in the configuration of a receiving portion. Specifically, the receiving portion of the fifth embodiment includes a protrusion 23j formed on the fence block 23. The protrusion 23j has an integral structure with the fence block 23 made of resin, and bulges from the outer surface 23b of the fence block 23 toward the cover plate 24. An outer end in the vehicle width direction of the protrusion 23j is positioned at an interval from the claw 32, and an inner end in the vehicle width direction of the protrusion 23j is continuous with the side wall of the fence block 23. That is, the protrusion 23j extends in the vehicle width direction along the insertion groove 23a and the reference line BL1.

In the door latch device 10 of the fifth embodiment, when the claw 32 is displaced via the striker 5 and the fork 31 by input of a collision load, the displaced claw 32 can be received by the protrusion 23j as in the first embodiment. At this time, the protrusion 23j has an integral structure with the fence block 23 made of resin, but extends in the vehicle width direction, which is the direction in which the claw 32 is displaced, and is continuous with the side wall of the fence block 23, so that the pressure resistance strength in the vehicle width direction is high. This prevents the claw 32 from unlocking the fork 31, thereby preventing the latch mechanism 30 from switching to unlatching and preventing unintended opening of the door 6 (see FIG. 1). In addition, since the receiving portion includes the protrusion 23j provided on the fence block 23 and it is not necessary to add a dedicated component, it is possible to prevent the assembly work from being complicated.

Note that the present invention is not limited to the configurations of the above embodiments, and various modifications can be made.

For example, in the door latch device 10 of the second embodiment illustrated in FIG. 14, the receiving portion of the third embodiment including the cut and raised piece 24h illustrated in FIG. 17, the receiving portion of the fourth embodiment including the cut and raised piece 25g illustrated in FIG. 19, or the receiving portion of the fifth embodiment including the protrusion 23j illustrated in FIG. 21 may be used. Moreover, the receiving portion may be provided on any component or may be formed of a dedicated component as long as displacement of the claw 32 due to input of a collision load can be prevented.

The claw shaft 32b may be provided separately from the claw body 32a, and the claw body 32a may be rotatable about the claw shaft 32b.

As long as rotation of the claw 32 beyond the locking position can be restricted via the open lever 33 at the normal time, the restricting portion may be configured of a part of the fence block 23 or a part of the set plate 25 without providing the separate stopper 37. The restricting portion may be configured to directly come into contact with the claw 32 to restrict the rotation of the claw 32 beyond the locking position.

As long as displacement of the claw 32 due to input of a collision load can be prevented, the receiving portion may be provided at a position not overlapping the claw 32 when viewed from the direction in which the insertion groove 23a extends.

As long as unlocking of the claw 32 with respect to the fork 31 due to input of a collision load can be prevented, the facing portion 32d of the claw 32 may have a shape other than the arc shape or the inclined shape.

The flange portion 32g of the claw 32 may not be provided as long as displacement of the claw 32 in the vehicle length direction along the claw shaft 32b can be prevented.

The door latch device 10 may be of a mechanical type including a lock mechanism capable of switching an operation force of a door handle included in the door 6 illustrated in FIG. 1 between an unlock position where the operation force can be transmitted to the claw 32 and a lock position where the operation force cannot be transmitted to the claw 32, and transmitting the operation force of the door handle to the latch mechanism 30 via the lock mechanism to switch the latch mechanism 30 in the latched state to unlatching.

### REFERENCE SIGNS LIST

1 vehicle body
2 outer panel
3 inner panel
4 end panel
5 striker
6 door
7 outer panel
8 inner panel
9 end panel
10 door latch device
20 housing
21 first accommodating portion
22 second accommodating portion
23 fence block (base member)
23a insertion groove
23b outer surface (one surface)
23c inner surface (the other surface)
23d to 23h through hole
23i restriction groove
23j protrusion (receiving portion)
24 cover plate
24a insertion groove
24b to 24g support hole
24h cut and raised piece (receiving portion)
25 set plate
25a to 25e support hole
25f restriction groove
25g cut and raised piece (receiving portion)
26A caulking shaft (receiving portion, shaft member)
26B caulking shaft (shaft member)
30 latch mechanism
31 fork
31a holding groove
31b locking protrusion
31d operation receiving portion
31e restricting protrusion
32 claw
32a claw body
32b claw shaft (rotation shaft)
32c mounting portion
32d facing portion
32e locking recess
32f locking surface
32g flange portion
33 open lever
33a mounting hole
33b operation receiving portion
33c contact piece
34 fork shaft (rotation shaft)
35,36 torsion spring (biasing member)
37 stopper (restricting portion)
40 electric release mechanism
41 actuating member
42 actuator
45 closure mechanism
46 closure lever
47 cable
48 rotation shaft
49 actuator
50 manual release mechanism
51 operation lever
52 rotation shaft
α interval (shortest distance between caulking shaft and claw body)
β interval (shortest distance between caulking shaft and claw body in direction in which claw is displaced)
γ locking allowance between claw and fork

1. A door latch device comprising:
a base member having an insertion groove through which a striker is insertable;
a fork that is disposed on the base member and is rotatable between a latch position at which the striker is held and an open position at which holding of the striker is released;
a claw that is disposed on the base member, is rotatable between a locking position at which the fork at the latch position is locked and an unlocking position at which the fork is unlocked, and is biased from the unlocking position toward the locking position;
a restricting portion that restricts rotation of the claw beyond the locking position; and
a receiving portion provided at an interval on a side opposite to the fork in a direction in which the insertion groove extends with respect to the claw at the locking position.

2. The door latch device according to claim 1, wherein the interval is smaller than a locking allowance between the claw at the locking position and the fork at the latch position.

3. The door latch device according to claim 1, wherein the receiving portion is provided at a position overlapping the claw as viewed from a direction in which the insertion groove extends.

4. The door latch device according to claim 1, wherein a portion of the claw facing the receiving portion has an arc shape centered on a rotation shaft of the claw.

5. The door latch device according to claim 1, wherein a portion of the claw facing the receiving portion is inclined in a direction approaching a rotation shaft of the fork as approaching the receiving portion, and a part of the portion is disposed closer to the rotation shaft than the receiving portion.

6. The door latch device according to claim 1, wherein the claw has a flange portion interposed between the fork at the latch position and the base member.

7. The door latch device according to claim 1 further comprising:
a cover plate that is disposed on one surface side of the base member on which the fork and the claw are disposed, and supports one end of a rotation shaft of each of the fork and the claw; and
a set plate that is disposed on another surface side opposite to the one surface side of the base member, and supports another end opposite to the one end of the rotation shaft of each of the fork and the claw.

8. The door latch device according to claim 7, wherein the receiving portion includes a shaft member that is a rigid body harder than the base member, and both ends of the receiving portion are supported by the cover plate and the set plate, respectively.

9. The door latch device according to claim 7, wherein the receiving portion includes a cut and raised piece formed on the cover plate that is a rigid body harder than the base member.

10. The door latch device according to claim 7, wherein the receiving portion includes a cut and raised piece formed on the set plate that is a rigid body harder than the base member.

11. The door latch device according to claim 7, wherein the receiving portion includes a protrusion having an integral structure bulging from the base member toward the cover plate, and extends along the insertion groove.

12. The door latch device according claim 2 further comprising:
a cover plate that is disposed on one surface side of the base member on which the fork and the claw are disposed, and supports one end of a rotation shaft of each of the fork and the claw; and
a set plate that is disposed on another surface side opposite to the one surface side of the base member, and supports another end opposite to the one end of the rotation shaft of each of the fork and the claw.

13. The door latch device according to claim 12, wherein the receiving portion includes a shaft member that is a rigid body harder than the base member, and both ends of the receiving portion are supported by the cover plate and the set plate, respectively.

14. The door latch device according to claim 12, wherein the receiving portion includes a cut and raised piece formed on the set plate that is a rigid body harder than the base member.

15. The door latch device according to claim 12, wherein the receiving portion includes a protrusion having an integral structure bulging from the base member toward the cover plate, and extends along the insertion groove.

16. The door latch device according claim 3, further comprising:
a cover plate that is disposed on one surface side of the base member on which the fork and the claw are disposed, and supports one end of a rotation shaft of each of the fork and the claw; and
a set plate that is disposed on another surface side opposite to the one surface side of the base member, and supports another end opposite to the one end of the rotation shaft of each of the fork and the claw.

17. The door latch device according to claim 16, wherein the receiving portion includes a shaft member that is a rigid body harder than the base member, and both ends of the receiving portion are supported by the cover plate and the set plate, respectively.

18. The door latch device according to claim 16, wherein the receiving portion includes a cut and raised piece formed on the cover plate that is a rigid body harder than the base member.

19. The door latch device according to claim 16, wherein the receiving portion includes a cut and raised piece formed on the set plate that is a rigid body harder than the base member.

20. The door latch device according to claim 16, wherein the receiving portion includes a protrusion having an integral structure bulging from the base member toward the cover plate, and extends along the insertion groove.

21. The door latch device according to claim 12, wherein the receiving portion includes a cut and raised piece formed on the cover plate that is a rigid body harder than the base member.
